(19) United States
(12) Patent Application Publication
(10) Pub. No.: US 2026/0024746 A1
(43) Pub. Date: Jan. 22, 2026

(54) BILAYER ANODE

(71) Applicant: FORD GLOBAL TECHNOLOGIES, LLC, Dearborn, MI (US)

(72) Inventor: Shiran ZHANG, Ann Arbor, MI (US)

(21) Appl. No.: 18/780,351

(22) Filed: Jul. 22, 2024

(51) Int. Cl. H01M 4/133; H01M 4/02; H01M 4/04; H01M 4/1393; H01M 4/62; H01M 4/66; H01M 10/0525; H01M 10/42

(52) U.S. Cl. CPC H01M 4/133; H01M 4/0404; H01M 4/1393; H01M 4/622; H01M 4/623; H01M 4/661; H01M 10/0525; H01M 10/4235; H01M 2004/027

(57) ABSTRACT

An electrode assembly for lithium-ion batteries is presented. The electrode assembly includes a metal foil current collector with a laminated active material layer adhered to it and an aligned active material layer on top. The laminated layer maintains adhesion with the current collector during electrochemical cycling of the electrode assembly, while the aligned layer provides lithium-ion diffusion pathways.

### TECHNICAL FIELD

The disclosure relates to anode materials for lithium-ion batteries.

### BACKGROUND

A challenge in the development and optimization of lithium-ion batteries is achieving fast-charging capability without compromising the thickness of the electrode material loading.

Graphite undergoes physical changes during the charge and discharge cycles of a lithium-ion (Li-ion) battery. During the charging process, known as lithiation, graphite expands as it absorbs Li-ions. Conversely, during the discharging process, known as de-lithiation, graphite shrinks as it releases Li-ions.

### SUMMARY

In one aspect of the disclosure, an electrode assembly is presented. The electrode assembly contains a metal foil current collector, with a laminated active material layer adhered to the metal foil current collector, and an aligned active material layer deposited on top of the laminated active material layer configured to provide diffusion pathways for lithium-ions during electrochemical cycling of the electrode. The metal foil current collector may be one of copper, aluminum, nickel, or titanium. The laminated active material layer may further contain a binder. The binder may be one of carboxymethyl cellulose, styrene-butadiene rubber, polyvinylidene fluoride. The laminated active material layer may further contain a solvent. The solvent may be N-methyl-2-pyrrolidone, a water-based solvent, an organic solvent, or other suitable solvents. In some configurations, the electrode assembly may further include a protective layer on the aligned active material layer.

In another aspect of the disclosure, a method for forming an electrode is presented. The method involves coating an active material slurry onto a metal foil current collector, laminating the active material slurry with the metal foil current collector to form a laminated layer on the metal foil current collector, and applying a magnetic field to active material particles deposited onto a surface of the laminated layer such that the active material particles align and project away from the laminated layer, resulting in a laminated-aligned bilayer electrode. The method may further include drying the active material slurry on the foil current collector after coating. A magnetic field from a neodymium magnet may be used for aligning the active material particles. In some configurations, the magnetic field used for aligning the active material particles may be an electromagnet. The metal foil current collector may be one of copper, aluminum, nickel, or titanium. The active material slurry may further contain a binder. The binder may be carboxymethyl cellulose, styrene-butadiene rubber, polyvinylidene fluoride. In other configurations, the active material slurry may further contain a solvent. The solvent may be N-methyl-2-pyrrolidone, a water-based solvent, an organic solvent. In a further configuration, the method may include applying a protective layer on top of the laminated-aligned bilayer electrode.

In yet another aspect of the disclosure, a lithium-ion battery is presented. The lithium-ion battery includes a positive electrode, a separator positioned adjacent to the positive electrode, and a negative electrode abutting the separator and including a metal foil current collector, with an active material layer laminated on the metal foil current collector, and an aligned active material layer deposited on the active material layer so as to define direct diffusion pathways for lithium-ions during electrochemical cycling of the lithium-ion battery. The active material layer and the aligned active material layer may be graphite-based. The aligned active material layer may be aligned using a magnetic field source.

### BRIEF DESCRIPTION OF THE DRAWINGS

FIG. 1 is a schematic diagram of lithium ion diffusion pathways in a laminated graphite anode;

FIG. 2 is a schematic diagram of lithium ion diffusion pathways in an aligned graphite anode;

FIG. 3 is a schematic diagram of a laminated graphite in a de-lithiated state;

FIG. 4 is a schematic diagram of a laminated graphite in a lithiated state;

FIG. 5 is a schematic diagram of an aligned graphite in a de-lithiated state;

FIG. 6 is a schematic diagram of an aligned graphite in a lithiated state;

FIG. 7 is a schematic diagram of an electrode according to one or more aspects of the disclosure;

FIG. 8 is a flowchart of a method for forming an electrode according to one or more aspects of the disclosure; and

FIG. 9 is a schematic diagram of a battery according to one or more aspects of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

To address the cycling stability of aligned active material electrodes, a laminated-aligned bilayer active material electrode is presented. This configuration delineates an electrode material coating into two layers, a lower laminated active material layer, which may be attached to a current collector, and an upper layer may be an aligned active material layer. The active material may be any suitable active material such as graphite.

The electrode is prepared by initially coating the laminated active material layer onto the current collector. The current collector may be composed of various metal foils such as copper, aluminum, or nickel, depending on the specific Li-ion battery design requirements. The configurability of metal foils allows for customization based on factors such as electrical conductivity, mechanical strength, and chemical stability. After the laminated active material layer is coated and dried, the aligned active material layer is then coated on top of the laminated active material layer.

The alignment of the active material flakes in the aligned active material layer may be produced via a magnet, such as a neodymium magnet, placed underneath the current collector. The diamagnetism of active material particles such as graphite along the hexagonal axis of its lattice compared to the basal plane causes the basal plane to orient parallel to the magnetic field. This alignment allows the active material flakes to remain vertically oriented relative to the current collector. The top aligned layer is subsequently dried using thermal or vacuum drying techniques, preserving the vertical orientation of the active material flakes established by the magnetic field. The alignment of the active material particles in this layer allows for effective Li-ion diffusion pathways for increasing fast-charging capabilities.

Additionally, various solvents and binder systems may be employed in the preparation process to optimize the coating and alignment of the active material flakes. Solvents such as N-methyl-2-pyrrolidone, water-based systems, and other organic solvents may be used depending on the desired electrode properties. These solvents facilitate the even distribution and proper adhesion of active material particles to the current collector. Binder systems may include polyvinylidene fluoride, carboxymethyl cellulose, or styrene-butadiene rubber, among others. These binder systems also contribute to the structural integrity of the electrode during lithiation and de-lithiation cycles.

For potential manufacturing applications, the magnetic field required for alignment may be provided by electromagnets, which may be adapted to suit the needs of Li-ion battery production processes. This approach not only retains the fast-charging capability of the aligned active material layer but also addresses horizontal strain issues that may lead to detachment and mechanical detachment in single-layer electrodes. The adaptability of the proposed manufacturing process allows for scaling up production while maintaining the precision needed for effective graphite alignment.

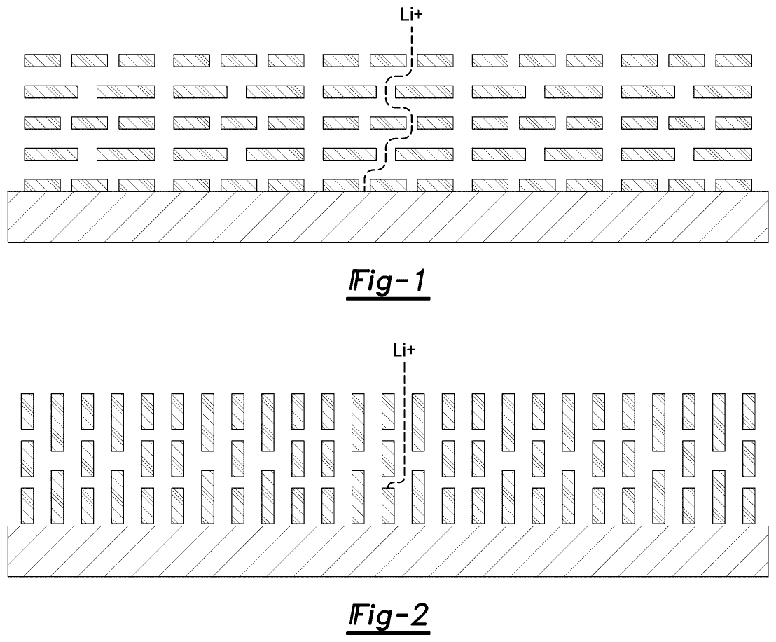

FIGS. 1-2, are schematic diagrams of Li-ion diffusion pathways in electrodes. In FIG. 1 a laminated graphite anode is shown. The active material layer of the anode is a laminated active material layer with horizontally aligned graphite particles on a current collector which may be a metal foil current collector. The horizontal alignment of the laminated particles results in a longer, less direct Li-ion diffusion pathway. In FIG. 2 an aligned graphite anode is shown. The active material layer of the anode is a vertically aligned graphite flake layer on a current collector which may also be a metal foil current collector. The vertical alignment of the graphite flakes creates a shorter, more direct Li-ion diffusion pathway. The direct diffusion pathways due to the vertically aligned graphite flake layer in the aligned graphite anode are in contrast to the indirect diffusion pathways of the horizontally aligned graphite particles in the laminated layer.

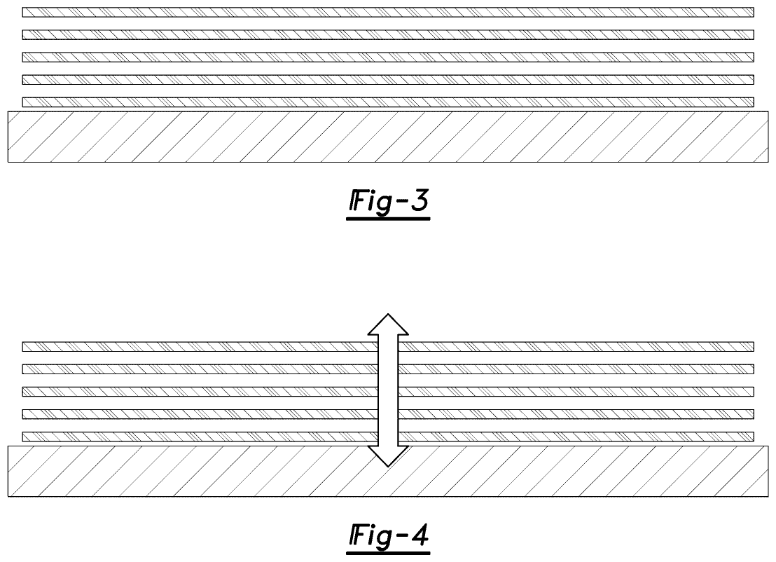

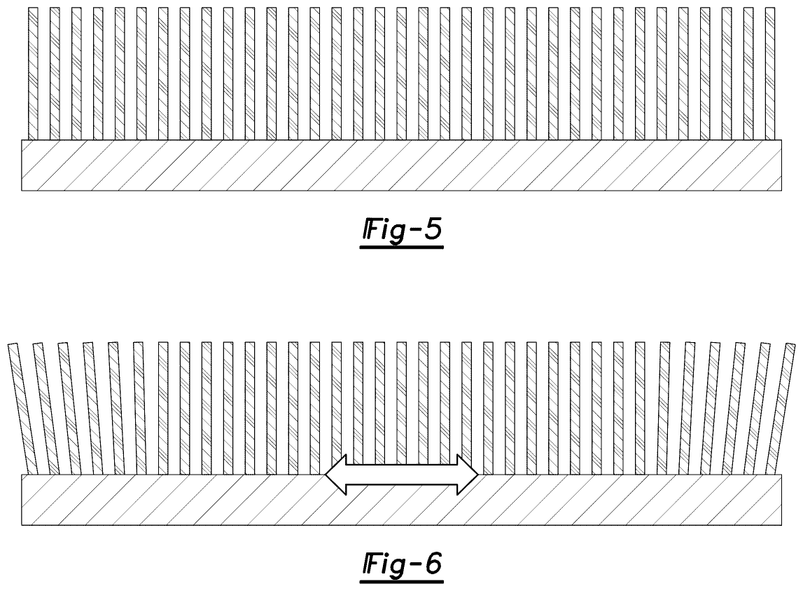

FIGS. 3-4 show a laminated graphite anode in de-lithiated and lithiated states, respectively. FIG. 3 is a schematic diagram of a laminated graphite anode in a de-lithiated state. The laminated graphite particles remain horizontally aligned on the metal foil current collector. This alignment limits the efficiency of Li-ion diffusion as ions must navigate a convoluted pathway through the horizontally oriented particles.

FIG. 4 is a schematic diagram of a laminated graphite anode in a lithiated state. The laminated graphite particles still exhibit horizontal alignment, but the expansion and contraction of graphite during lithiation and de-lithiation are evident. The vertical expansion and shrinkage create stress within the electrode, which can lead to mechanical instability over repeated charge and discharge cycles.

FIGS. 5-6 show an aligned graphite anode in de-lithiated and lithiated states, respectively. FIG. 5 is a schematic diagram of an aligned graphite anode in a de-lithiated state. The vertically aligned graphite flakes are shown on the metal foil current collector. This vertical alignment facilitates a more direct Li-ion diffusion pathway, enhancing the efficiency of ion transport within the electrode.

FIG. 6 is a schematic diagram of an aligned graphite anode in a lithiated state. The vertically aligned graphite flakes expand and contract horizontally upon lithiation and de-lithiation, respectively. This horizontal strain, caused by the graphite expansion and shrinkage, can lead to potential displacement of graphite from the current collector surface, resulting in delamination and cracking. The proposed bilayer configuration mitigates this issue by using a laminated active material layer attached to the metal foil current collector to absorb horizontal strain, maintaining the integrity of the aligned graphite layer on top and preserving its fast-charging capabilities.

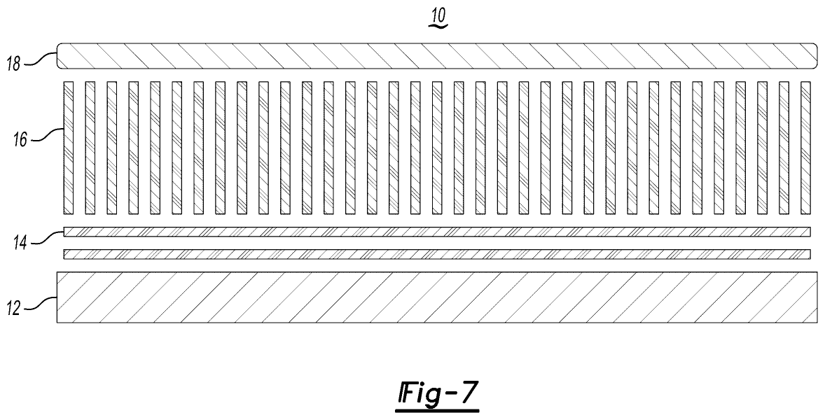

FIG. 7 is a schematic diagram of an electrode assembly 10 according to one or more aspects of the disclosure. The electrode assembly comprises a metal foil current collector 12, a laminated active material layer 14 adhered to the metal foil current collector 12, and an aligned active material layer 16 deposited on top of the laminated active material layer 14. A protective layer 18 is present on top of the aligned active material layer 16. The metal foil current collector 12 may be composed of copper, aluminum, nickel, or titanium, depending on the specific application and design requirements of the electrode assembly 10. The metal foil current collector 12 provides a stable and conductive substrate for the laminated active material layer 14 and the aligned active material layer 16, maintaining efficient Li-ion electron transport during electrochemical cycling of the electrode assembly 10.

The laminated active material layer 14 is adhered to the metal foil current collector 12. This laminated active material layer 14 contains active material particles, such as graphite, dispersed within a binder matrix. The binder may be one of carboxymethyl cellulose, styrene-butadiene rubber, polyvinylidene fluoride, or other suitable binders that provide mechanical integrity and adhesion to the metal foil current collector 12. The laminated active material layer 14 may also contain a solvent to facilitate the dispersion and coating process. Suitable solvents include N-methyl-2-pyrrolidone, water-based solvents, organic solvents, or other appropriate solvents.

The aligned active material layer 16 may be deposited on top of the laminated active material layer 14. This aligned active material layer 16 includes active material particles aligned in a vertical orientation to increase Li-ion diffusion pathways during electrochemical cycling. The vertical alignment creates direct diffusion pathways for Li-ions. The direct diffusion pathways in the aligned active material layer 16 allow for more efficient Li-ion transport, improving performance of the electrode assembly 10, particularly during fast-charging and discharging cycles. The alignment of the graphite particles may be achieved using various types of magnets. Neodymium magnets, known for their strong magnetic fields, may be used to effectively orient the graphite particles. Alternatively, electromagnets may be employed, allowing for adjustable magnetic field strengths and the ability to switch the field on and off as needed during manufacturing. These magnets facilitate the alignment of the active material particles, for increased performance of the electrode assembly 10. A protective layer 18 may be deposited on top of the aligned active material layer 16. This protective layer 18 may be composed of materials that prevent degradation of the aligned active material layer 16 and provide additional mechanical stability to the electrode assembly 10.

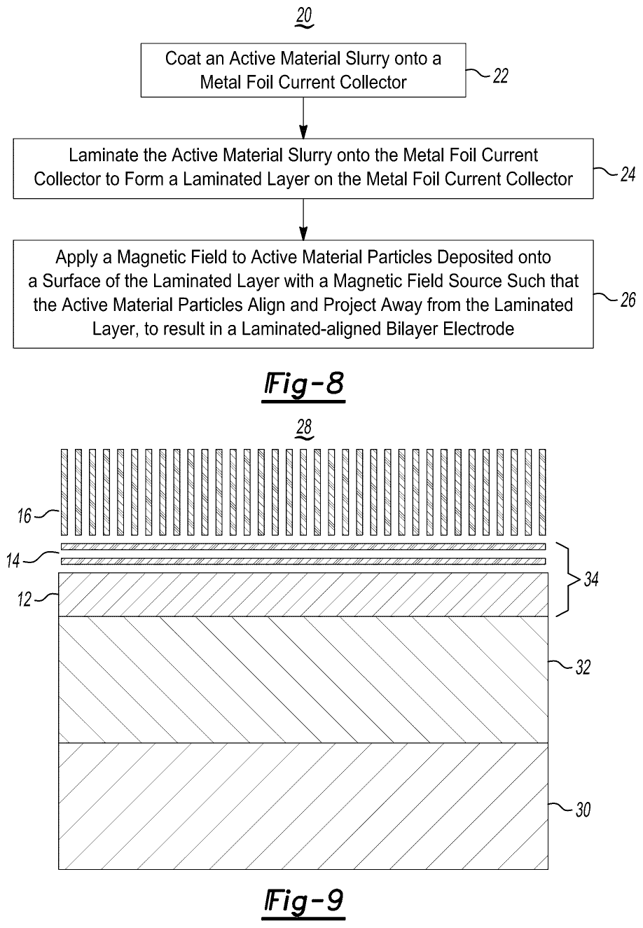

FIG. 8 is a flowchart of a method 20 for forming an electrode according to one or more aspects of the disclosure. The method 20 begins with step 22, which involves coating an active material slurry onto a metal foil current collector. The metal foil current collector may be composed of materials such as copper, aluminum, nickel, or titanium. The active material slurry may contain a binder, which may be one of carboxymethyl cellulose, styrene-butadiene rubber, polyvinylidene fluoride, or another suitable binder. Additionally, the slurry may include a solvent, such as N-methyl-2-pyrrolidone, a water-based solvent, an organic solvent, or another appropriate solvent. After coating, the active material slurry is dried on the metal foil current collector.

Next, in step 24, the active material slurry is laminated onto the metal foil current collector to form a laminated layer on the metal foil current collector. This laminated layer provides a foundation for the subsequent deposition of the aligned active material layer. In step 26, a magnetic field is applied to the active material particles deposited onto the surface of the laminated layer with a magnetic field source. The magnetic field source may be a neodymium magnet or an electromagnet. The magnetic field aligns the active material particles so they project away from the laminated layer, resulting in a laminated-aligned bilayer electrode. This alignment increases the Li-ion diffusion pathways, and subsequently the performance of the electrode during electrochemical cycling, particularly for fast-charging and discharging applications. Optionally, the method 20 may further include applying a protective layer on top of the laminated-aligned bilayer electrode to prevent degradation and provide additional mechanical stability to the electrode assembly.

FIG. 9 is a schematic diagram of a Li-ion battery 28 according to one or more aspects of the disclosure. The Li-ion battery 28 has a positive electrode 30, a separator 32 positioned adjacent to the positive electrode 30, and a negative electrode 34 abutting the separator 32. The negative electrode 34 includes the metal foil current collector 12 with the laminated active material layer 14 laminated on it to maintain adhesion of the laminated active material layer 14 to the metal foil current collector 12 during electrochemical cycling. Additionally, the aligned active material layer 16 is deposited on top of the laminated active material layer 14.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

While the present disclosure has been described with respect to certain embodiments and specific examples, it is to be understood that the invention is not limited to these embodiments and examples. Various modifications, changes, and adaptations can be made by those skilled in the art without departing from the scope and spirit of the invention. For instance, the specific types of active materials, solvents, binders, and current collectors described herein may be varied based on desired performance characteristics and application requirements.

The methods and systems described herein are applicable to a variety of industrial applications, including but not limited to, the manufacture of Li-ion batteries, capacitors, and other electrochemical energy storage devices. The invention can be particularly advantageous for applications requiring high cycling stability, fast-charging capabilities, and electrode performance.

What is claimed is:

1. An electrode assembly comprising:
a metal foil current collector;
a laminated active material layer adhered to the metal foil current collector; and
an aligned active material layer deposited on the laminated active material layer and configured to provide diffusion pathways for lithium-ions during electrochemical cycling of the electrode.

2. The electrode assembly of claim 1 wherein the metal foil current collector is copper, aluminum, nickel, or titanium.

3. The electrode assembly of claim 1 wherein the laminated active material layer further contains a binder.

4. The electrode assembly of claim 3 wherein the binder is carboxymethyl cellulose, styrene-butadiene rubber, or polyvinylidene fluoride.

5. The electrode assembly of claim 1 wherein the laminated active material layer further contains a solvent.

6. The electrode assembly of claim 5 wherein the solvent is N-methyl-2-pyrrolidone, a water-based solvent, or an organic solvent.

7. The electrode assembly of claim 1, further comprising a protective layer on the aligned active material layer.

8. A method for forming an electrode comprising:
coating an active material slurry onto a metal foil current collector;
laminating the active material slurry with the metal foil current collector to form a laminated layer on the metal foil current collector; and
applying a magnetic field to active material particles on a surface of the laminated layer such that the active material particles align and project away from the laminated layer, resulting in a laminated-aligned bilayer electrode.

9. The method of claim 8, further comprising drying the active material slurry after the coating.

10. The method of claim 8 wherein the magnetic field is generated via a neodymium magnet.

11. The method of claim 8 wherein the magnetic field is generated via an electromagnet.

12. The method of claim 8 wherein the metal foil current collector is copper, aluminum, nickel, or titanium.

13. The method of claim 8 wherein the active material slurry further contains a binder.

14. The method of claim 13 wherein the binder is carboxymethyl cellulose, styrene-butadiene rubber, or polyvinylidene fluoride.

15. The method of claim 8 wherein the active material slurry further contains a solvent.

16. The method of claim 15 wherein the solvent is N-methyl-2-pyrrolidone, a water-based solvent, or an organic solvent.

17. The method of claim 8, further comprising applying a protective layer on the laminated-aligned bilayer electrode.

18. A lithium-ion battery comprising:
a positive electrode;
a separator positioned adjacent to the positive electrode; and
a negative electrode abutting the separator and including a metal foil current collector, an active material layer laminated on the metal foil current collector, and an aligned active material layer deposited on the active material layer so as to define direct diffusion pathways for lithium-ions during electrochemical cycling of the lithium-ion battery.

19. The lithium-ion battery of claim 18 wherein the active material layer and the aligned active material layer are graphite-based.

20. The lithium-ion battery of claim 18 wherein the aligned active material layer is aligned using a magnetic field source.
